(19) United States
(12) Patent Application Publication
(10) Pub. No.: US 2012/0287757 A1
(43) Pub. Date: Nov. 15, 2012

(54) Forward Looking Seismics From Drill-Bit

(75) Inventors: Bjørn A. J. ANGELSEN, Trondheim (NO); Erling FJÆR, Tiller (NO); Ketil Bø, Trondheim (NO)

(73) Assignee: SURF Technology AS, Trondheim (NO)

(21) Appl. No.: 13/467,622

(22) Filed: May 9, 2012

Related U.S. Application Data
(60) Provisional application No. 61/484,043, filed on May 9, 2011.

(51) Int. Cl. G01V 1/18

(52) U.S. Cl. 367/178

(57) ABSTRACT

Methods and instrumentation for detecting and representing at least one geologic formation in front of an operating drill-bit using the vibration noise generated by the operating drill-bit as a source, comprising at least one receive array comprising more than one receive vibration sensor elements, said at least one receive array are located in one or both of i) at least one receive well, and ii) submerged in water for sub-sea operation, and beam forming at least one receive signal from the signals from said more than one receive elements of said at least one receive array, and forming at least one reference signal representing the vibrations of the operating drill-bit, and correlating said at least one receive signal with said at least one reference signal with different correlation lags, and forming a seismic representation of the at least one geologic formation in front of the drill-bit through said correlating.

### CROSS REFERENCE TO RELATED APPLICATIONS

This application claims, under 35 U.S.C. §119(e), priority of U.S. Provisional Application Ser. No. 61/484,043, which was filed with the U.S. Patent and Trademark Office on May 9, 2011, the content of which is incorporated herein by reference in its entirety.

### BACKGROUND OF THE INVENTION

1. Field of the Invention

The current invention relates to seismic observation of geologic formation in front of a drill-bit.

2. Description of the Related Art

During drilling it is important to observe the formation in front of an operating drill-bit to avoid unexpected breakthrough into new formations with the risk of stuck pipe or blow out.

An efficient method for such observation that has limited interference with the drilling is therefore in high demand.

The rotating drill-bit produces random vibrations that propagate into the formation, and also forward from the drill-bit. This opens opportunities to utilize these vibrations for observations of seismic reflections in front of the drill-bit.

An example of such an observation is given in the article J. W. Rector III and B. P. Marion: “The use of drill-bit energy as a down-hole seismic source” Geophysics Vol. 56, No. 5, May 1991, pp 628-634. In this method a 1^{st} sensor picks up the vibration noise generated by the drill-bit at the upper end of the drill-string. In addition at least one 2^{nd} vibration sensor is placed on the surface at a distance from the borehole. The signals from these at least two sensors are correlated with different time lags to identify reflections from different structures in front of the drill-bit.

This method has weaknesses in the sensitivity of the reflections in front of the drill-bit, and also in the identifiability of different reflections with respect to direction and distance from the drill-bit.

The current invention solves these problems through several inventive measures.

### SUMMARY OF THE INVENTION

Methods and instrumentation for detecting and representing at least one geologic formation in front of a drill-bit using the vibration noise generated by the operating drill-bit, and using at least one receive array of more than one receive vibration sensor in at least one receive well or submerged in water for sub-sea operation, to form at least one receive signal from the signals from said more than one receive vibration sensor elements, and correlating said at least one receive signal with at least one reference signal with different correlation lags, to form a seismic representation of the at least one geologic formation in front of the drill-bit through said correlating.

The at least one reference signal can be obtained from at least one reference vibration sensor connected to the drill-bit string, or can be obtained through beam forming of the received signals from said at least one receive vibration sensors of said at least one receive array.

The at least one receive signal is obtained through beam forming of the received signals from said receive vibration sensor elements of said at least one receive array.

The invention also devices to use more than one receive array in more than one receive well to improve signal to noise ratio of one of the at least one receive signal and the at least one reference signal.

The invention further devices to use more than one receive array in more than one receive well to improve 3D representation of the geologic formations in front of the drill-bit.

The invention further devices to measure the position of the individual receive elements, and take the measured positions into account in the receive beam forming.

The invention also includes instrumentation for carrying through the methods in a practical situation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a vertical cross section overview of essential components of the invention in the formation;

FIG. 2 is a birds eye view of an example arrangement of the drilling tower and multiple recoding wells according to the invention;

FIG. 3 is a block diagram of an instrument according to the invention; and

FIG. 4 shows an arrangement of line arrays floating in the sea and anchored to the sea bottom, according to the invention.

### DETAILED DESCRIPTION OF THE PREFERRED EMBODIMENTS

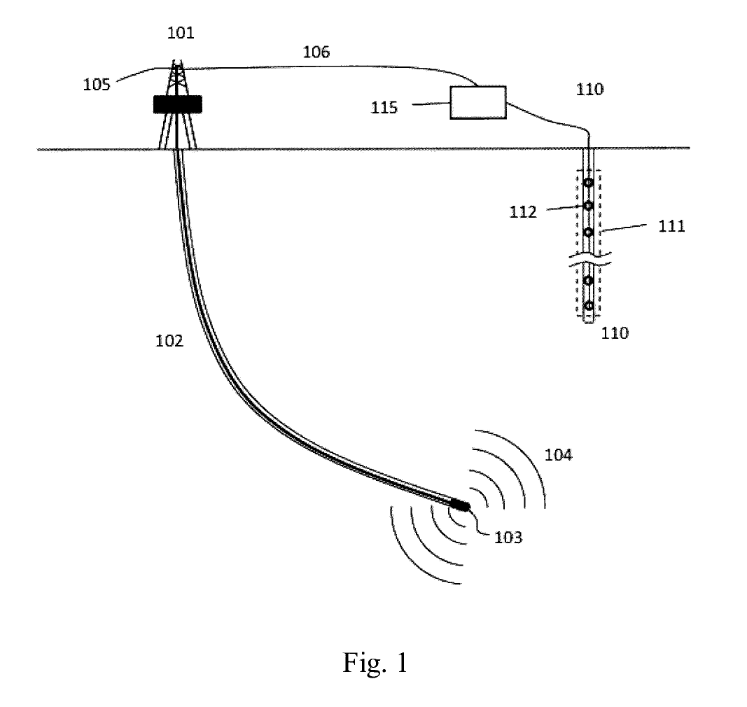

Essential aspects of the invention are illustrated in FIG. 1, where 101 shows a conventional drilling rig system with the borehole 102 and the drill-bit 103 as the vibration noise source. The noise wave from the drill-bit is indicated as 104. In a second bore hole 110 is placed a receive sensor array 111 composed of a set of individual vibration sensor elements 112. The receive signals from the vibration sensors are fed to a processing unit 115. The signal from the individual sensors are defined as sᵢ(t) where i=1, . . . , I denotes a numbering (labeling) of the array elements. A 1^{st} step of the processing unit is a receive beam forming, where the signals from the individual sensor elements of the array are modified through a delay and amplitude adjustment. These modified signals are summed to form a directional sensitive beam formed signal of the array as

$${y}_{k} ( t ) = {\sum }_{i = 1}^{I} {a}_{ki} {s}_{i} ( t - {τ}_{ki} ) k = 1 , … , K \qquad ( 1 )$$

The subscript k denotes that the beam forming can provide multiple signals, labeled k, in parallel, with different directional sensitivity. For example, the beam forming unit can provide one directional signal that focuses on the drill-bit to form a reference signal of the noise source, and another directional signal that focuses at a defined and potentially also variable depth in front of the drill-bit.

The advantage with directional sensitive array signals as in Eq. (1) is that the signal to noise power ratio increases in proportion to I, i.e. the number of sensor elements, for signals from the receiver focus. Directional signals also provide a spatial suppression of undesired, disturbing signals from strong reflectors at other locations outside the focus or multiple scattered signals, referred to as clutter noise. In one aspect of the invention, the receive array is equipped with spatial position sensing instrumentation, for example for each or a group of sensor element, to provide less sensitivity to improve accuracy in the known position of the array elements that is taken into account in the estimation of the signal delays τₖᵢ for improved directional positioning and sensitivity of the receive beams. Such position sensing can be based on either acoustic or electromagnetic waves, or both, in relation to known transmitters or receivers according to methods known or derivable by anyone skilled in the art. One can also advantageously make use of the public GPS. The directivity of the receive beam can further be improved through adjusting the signal delays τₖᵢ and gain factors aₖᵢ to maximize the signal power of the received signals from reflectors.

At least one directional sensitive array signal is correlated in time with a reference signal representing the vibration noise signal emitted from the drill-bit. Such a reference signal can for example be obtained from a vibration sensor connected to the drill-string, for example the sensor 105 placed at the upper end of the drill-string and connected to the processor 115 through the line 106. The reference signal can also be obtained as another directional array signal, for example a directional array signal that focuses on the drill-bit itself. The directionality of this receive beam can be improved through adjusting the signal delays τₖᵢ and gain factors aₖᵢ to maximize the signal power, as the drill-bit produces a stronger signal than those signals reflected from this signal.

The correlation is done with different time lags to identify scatterers/reflectors with different distance from the drill-bit.

We should note that the individual components of the processing unit as described above, would in most situations be implemented as software components in a single computer system, where we have used the term component to enhance specific structures of the processing.

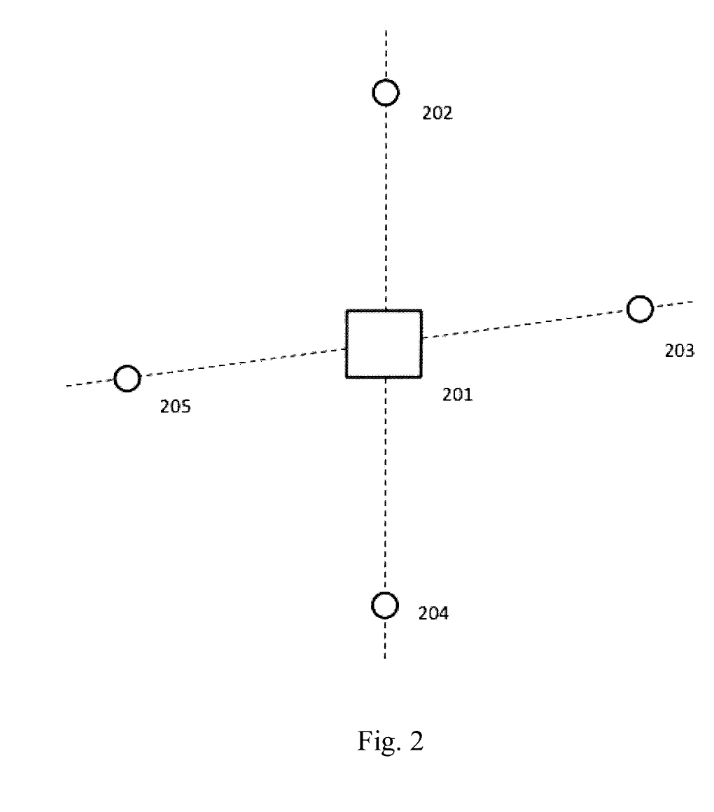

FIG. 2 is a birds eye view of the drill-bit tower 201 with four receive arrays 202-205 that are used in parallel to improve signal to noise ratio and three-dimensional (3D) positioning of the directional sensitivity of the receive beam in relation to 3D geological formations. The invention devices the use of more than one receiver array for this purpose.

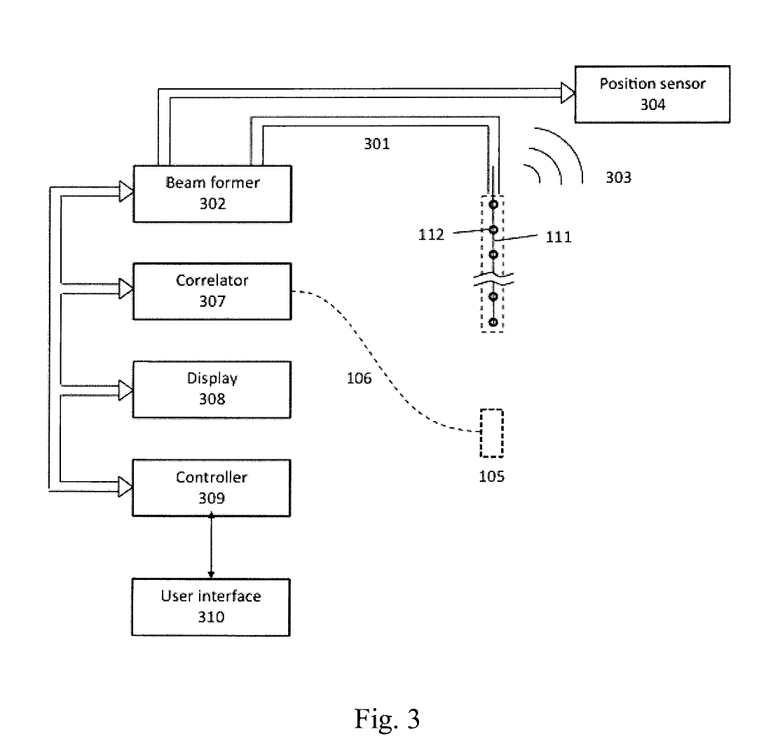

FIG. 3 is a block diagram of a complete receive instrumentation according to the invention, where 111 shows one of the at least one receive arrays comprising several receive elements 112.

The signals from the array elements are transmitted via the communication link 301 to the instrument beam former 302 that for example operates according to Eq. (1), where the beam former estimates τₖᵢ and aₖᵢ as described above, to form at least one receive signal. Said receive array can optionally for each receiver element contain receiver amplifiers so that amplified analog signals are transmitted to the beam former. The receive array can also optionally contain analog to digital converters for each element signal so that digital signals can be transmitted to the beam former. The beam former can also be integrated into the array assembly, so that one can transmit digital, beam-formed signals to the instrument unit. The invention covers all these variations as they are part of state of the art of modern electronics and signal processing. The block diagrams of the Figure hence shows conceptual units, and not the detailed implementation, where for example blocks in the diagram can be implemented as software in a computer.

The receive array can also optionally be equipped with position sensing devices that for example interacts via acoustic or electromagnetic waves, or both, indicated as 303, with an external position sensing unit 304, that interacts with the rest of the instrumentation via the communication link 305. Through this one obtains accurate spatial position of the individual array elements that can be used in the estimation of the delay corrections in the beam forming as described above. The position sensing can be of several types that are known by any-one skilled in the art, for example triangulation in a transponder system, or detection of phase of the transmitted signal from multiple transmitters. One could also make use of the public satellite Geo-Positioning System (GPS).

The different blocks of the instrument are by example in FIG. 3 shown to communicate via a bus 306, while other ways to communicate between the blocks can be established by any-one skilled in the art. The beam formed signals from the beam former are transmitted via the bus 306 to the correlator 307 where the beam formed signals are correlated with a reference signal as described above. Said reference signal can be obtained as a beam formed signal focused on the drill-bit source (103), or from an optional separate sensor 105, as described in FIG. 1.

The outputs of the correlator are then transferred to the display unit 308 to visualize structures in front of the drill-bit. The system is set up and controlled by a controller 309 that takes input from a user interface 310.

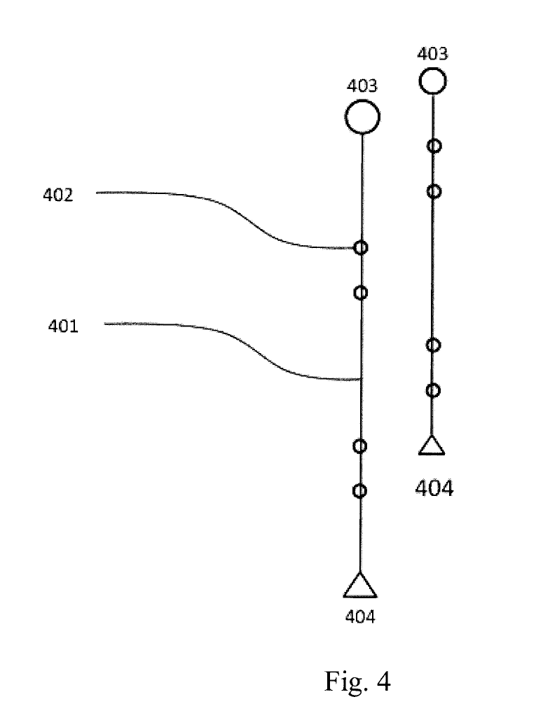

In FIGS. 1 and 2 the receive arrays 111 and 202-205 are placed in boreholes drilled into the ground. However, the arrays could also according the invention be submerged in the sea above the sea-bottom for sub-sea operations, for example as shown in FIG. 4. This Figure shows by example three vertical line arrays 401 with array elements 402 hanging from flotation buoys 403, and anchored to the sea-bottom by the anchors 404. However, by placing the receive arrays 111 in adequately deep boreholes 110 as shown in FIG. 1 the sensitivity to the signals generated by the drill-bit vibrations is improved, especially at higher frequencies improving the spatial resolution in the seismic detection and imaging.

Thus, while there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention.

It is also expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for detecting and representing at least one geologic formation in front of an operating drill-bit using the vibration noise generated by the operating drill-bit as a source, the method comprising:
using at least one receive array comprising more than one receive vibration sensor elements, said at least one receive array are located in one or both of i) at least one receive well, and ii) submerged in water for sub-sea operation,
beam forming at least one receive signal from the signals from said more than one receive elements of said at least one receive array,
forming at least one reference signal representing the vibrations of the operating drill-bit,
correlating said at least one receive signal with said at least one reference signal with different correlation lags, and
forming a seismic representation of the at least one geologic formation in front of the drill-bit through said correlating.

2. A method according to claim 1, where said at least one reference signal is obtained from at least one reference vibration sensor connected to the drill-string.

3. A method according to claim 1, where said at least one reference signal is obtained through beam forming of the receive signals from said more than one receive elements of said at least one receive array.

4. A method according to claim 1, where said at least one receive signal is obtained through beam forming of the receive signals from said more than one receive elements of said at least one receive array.

5. A method according to claim 1, where more than one receive array at different locations is used to improve i) signal to noise ratio of one of the at least one receive signal and the at least one reference signal, and ii) 3D representation of the at least one geologic formation in front of the drill-bit.

6. A method according to claim 1, where said seismic representation of the at least one geologic formation in front of the drill-bit is done in the form of a 2D or 3D image.

7. A method according to claim 1, where the positions of the individual receive array elements are measured and the measured positions are taken into account in the estimation of the delay corrections in the beam forming to form the directional sensitivity of the receive beams.

8. A method according to claim 1, where at least one receive array is placed in a borehole into the ground or the sea bottom.

9. A method according to claim 1, where delay corrections in the beam forming are adjusted to optimize the directional resolution of the receive beam.

10. An apparatus for detecting and representing of geologic structures in front of an operating drill-bit using the noise generated by the operating drill-bit as a source, the apparatus comprising:
at least one receive array comprising more than one receive vibration sensor elements, said at least one receive array are located in one or both of i) at least one receive well, and ii) submerged in water for sub-sea operation,
means for beam forming at least one receive signal from the signals from said more than one receive sensor elements of said at least one receive array,
means for forming at least one reference signal,
means for correlating said at least one receive signal with said at least one reference signal with different correlation lags, and
means for forming a seismic representation of the at least one geologic formation in front of the drill-bit through said correlating.

11. An apparatus according to claim 10, where said means for forming at least one reference signal comprises a vibration sensor connected to the drill-string.

12. An apparatus according to claim 10, where said means for forming at least one reference signal is a beam forming means for the received signals from said more than one receive vibration sensor elements of said at least one receive array.

13. An apparatus according to claim 10, where said means for forming at least one receive signal is a beam forming means for the received signals from said more than one receive sensor elements of said at least one receive array.

14. An apparatus according to claim 10, where said at least one receive array is at least two receive arrays located at different positions to form a composite receive array composed of at least two receive arrays in order to of improve at least one of i) signal ratio of said receive signals, and ii) 3D representation of the geologic structures in front of the drill-bit.

15. An apparatus according to claim 10, comprising means for measuring the positions of the individual receive elements.

16. An apparatus according to claim 10, where said means for seismic representation of the at least one geologic formation in front of the drill-bit is an image display for displaying 2D or 3D images of said at least one geologic formation.

17. An apparatus according to claim 10, where said means for beam forming includes means for adjusting the delay corrections to optimize the directional resolution of the receive beam.
